(19) United States
(12) Patent Application Publication
(10) Pub. No.: US 2016/0001459 A1
(43) Pub. Date: Jan. 7, 2016

(54) PLUG CUTTER AND METHOD FOR INLAYING PLUGS

(71) Applicant: LUCAS GHEKIERE, Houthalen (BE)

(72) Inventor: LUCAS GHEKIERE, Houthalen (BE)

(73) Assignee: E I DU PONT DE NEMOURS AND COMPANY, Wilmington, DE (US)

(21) Appl. No.: 14/745,543

(22) Filed: Jun. 22, 2015

Related U.S. Application Data
(60) Provisional application No. 62/019,520, filed on Jul. 1, 2014.

(51) Int. Cl. B27G 13/00

(52) U.S. Cl. CPC B27G 13/002

(57) ABSTRACT

A plug cutter for machining plug from a workpiece of wood, solid surface materials, and the like. The bit includes a straight shank portion adapted to be gripped in chucks or collets of a router or CNC machine, and a 1° tapered fluted cutting portion. Also, a process for using the plug cutter to machine plugs for inlaying into surfaces.

### BACKGROUND OF THE INVENTION

1. Field of Invention

The invention relates to a device for cutting plugs from a workpiece, and a method for inlaying the plugs into a surface.

2. Description of the Related Art

The disclosed invention is directed generally to solid surface fabrication and woodworking and more specifically to plug repair and the tooling which is suitable to create plugs.

In the fabrication of solid surfacing or wooden materials it is useful to inlay plugs of similar or dissimilar materials, for various reasons. For instance, a plug of similar solid surface material may be inlaid into a solid surface countertop to seamlessly and invisibly repair a flaw. Another example would be the inlaying of a hardwood plug into solid surfacing or softwood objects to provide a secure screw holding material when the material of construction of the object is not suitable for holding screws. A further example would be the inlay of dissimilar materials into an object for decorative effect.

While different methods or techniques can be used for the machining of plugs, one popular approach is to use a plug cutter. Typically these cutters cut frustoconical plugs from a board. U.S. Pat. No. 5,681,134 to Ebert and U.S. Pat. No. 6,599,065 to Haughton et al. are representative of this class of cutter. In typical use the shank of a plug cutter is chucked into a drill press and rotated while the cutter is plunged into the board, cutting the frustoconical plug along the axis of the shank. A plug cutter machines a plug of a defined size. For each plug cutter a corresponding bevel bit is required. The bevel bit cuts a tapered hole in the surface to be repaired that matches the size of the corresponding plug. To accomplish plug repairs of various sizes, multiple matched sets of plug cutters and bevel bits are required. Matched plug repair sets suffer from limitations. Matched sets of plug cutters and bevel bits are expensive. Plug cutters and bevel bits are limited to their defined size. Matched sets are generally unavailable in sizes less than 10 mm. The plug cutters and bevel bits require periodic sharpening, and after sharpening the plug cutter and bevel bits are no longer a match. Furthermore, the plugs cut using frustoconical plug cutters suffer from limitations. Frustoconical plugs require pressure to be applied to the plug until after curing of the adhesive used to complete the repair. This entails labor intensive clamping of each plug. Also, the routing down and finishing of frustoconical plugs is labor intensive.

There is a need for an economical tool for forming plugs of various sizes that does not require labor intensive techniques for inlaying the plugs.

### SUMMARY OF THE INVENTION

### Brief Description of the Drawings

FIG. 1 is a perspective view of the plug cutter.

FIG. 2A is an isometric view of the plug cutter of FIG. 1 cutting various sized plugs from a workpiece.

FIG. 2B is a side view of the board of FIG. 2A with plugs cut using the plug cutter of FIG. 1.

FIG. 3 is an isometric view of various stages of the plug of FIG. 2A being inlaid into a surface.

### DETAILED DESCRIPTION OF THE PREFERRED EMBODIMENTS

The plug cutter 100 of the invention is a tapered router bit as shown in FIG. 1. The plug cutter is comprised of a straight shank 110 portion, and a tapered, fluted, cutting portion 120. The straight shank 110 is sized and shaped to fit the collet of typical routers and CNC machinery. The tapered cutting portion 120 is tapered 1° in relation to the centerline 130 from the shank to the distal end of the bit. The tapered cutting portion 120 has fluted cutters of the type well known to the art. The bit may be made from steel, high speed steel, carbon alloy steel, carbide, or a combination thereof. Plug cutters of this design are inexpensive to manufacture.

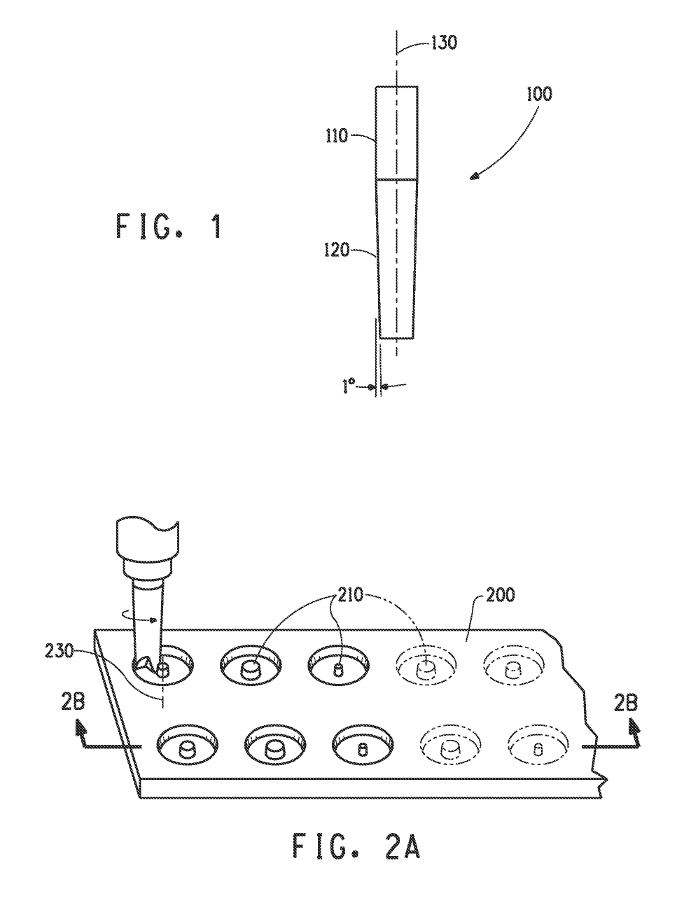

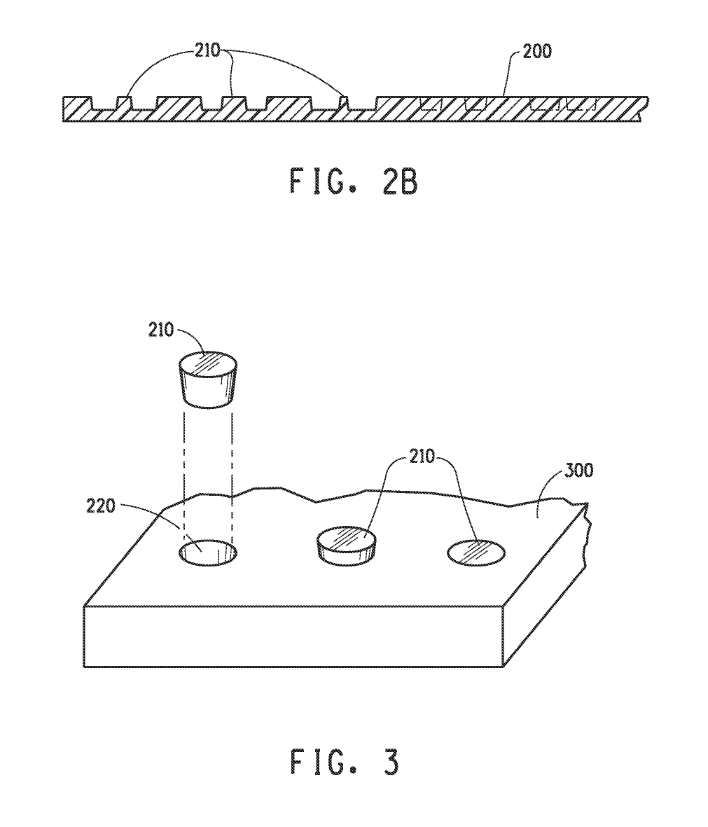

The plug cutter is used to machine plugs for inlaying into surfaces. The plug cutter may be used with a router or CNC machine to machine plugs. The preferred machine is a CNC machine. The process of machining a plug comprises orbiting the rotating plug cutter around a centerline of the plug while simultaneously plunging the plug cutter into a workpiece. The shank 110 of the plug cutter is chucked into a CNC machine and driven in a rotating manner by the chuck. In addition to rotating the bit, the CNC machine is programmed to orbit the bit around the centerline 230 of the plug. The bit is juxtaposed to a workpiece 200 from which plugs are to be machined. The plug cutter is rotated and orbited around centerline 230 while simultaneously plunging the plug cutter into the workpiece 200 to create a plug 210, as shown in FIG. 2A and FIG. 2B. The size of the plug 210 that is machined is related to the distance the plug cutter 100 is orbited about the centerline 230. The CNC machine may be programmed to machine any combination of same or different sized plugs from the workpiece 200. Plugs of large sizes may be conveniently made with the relatively small plug cutter 100. Workpiece 200 may be of any material suitable for machining and inlaying. The preferred materials are wood and solid surface materials.

The plugs 210 created by plug cutter 100 are used for inlaying into a surface 300. The inlaying may be for decorative or functional purposes. The method comprises drilling a hole into the surface 300, adhesively bonding a plug 210 into the hole in surface 300, and finishing the surface to smooth the plug 210.

A hole 220 is bored into surface 300 using a typical drill bit, or router bit, with straight sides. Drill bits may be driven by hand drills, power drills, drill presses, or CNC machine. Router bits may be driven by routers, plunge routers, or CNC machines. The hole 220 is drilled at any location in surface 300 to achieve a decorative effect, or at a blemished or flawed location that requires a repair. In the case of a repair, the size of hole 220 should be larger than the blemish or flaw.

A plug 210 with a 1° taper that was machined with plug cutter 100 is adhesively bonded into the hole drilled into surface 300. The plug 210, or the hole, or both are coated with an adhesive and the plug 210 is inserted into the hole. The plug 210 does not have to be pushed down firmly, just gently turned in. The preferred adhesive for solid surface materials is joint adhesive. The preferred adhesive for wood is wood glue. The 1° angle of plug 210 makes it slightly conical and it will tightly fit the straight hole without requiring means for continued pressure, such as a clamp.

The surface 300 is finished after the adhesive has set. For inlays set into sold surface materials, it is found particularly useful to cut off any exposed portion of the inlaid plug by using an oscillating saw. The finishing is completed by sanding the area of the inlay. Finishing is very fast and easy, and creates almost no dust. The inlay created this way is very nicely finished, and shows no whitening. A strong and inconspicuous surface inlay is created.

What is claimed is:

1. A plug cutter comprising:
a) a straight shank portion on a first end; and
b) a fluted cutting portion tapered 1° toward the distal end.

2. A process for machining a plug from a workpiece comprising:
a) orbiting the rotating plug cutter around a centerline of the plug; and
b) simultaneously plunging the plug cutter into the workpiece.

3. A plug machined using the process of claim 2.
